(19) United States
(12) Patent Application Publication
(10) Pub. No.: US 2009/0241619 A1
(43) Pub. Date: Oct. 1, 2009

(54) Latch Lock

(75) Inventors: Thorsten Kuester, Remscheid (DE); Klaus Bergmann, Essen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: DIRAK Dieter Ramsauer Konstruktionselemente GmbH & Co. KG

(21) Appl. No.: 12/086,668

(22) PCT Filed: Nov. 8, 2006
(86) PCT No.: PCT/EP2006/010684

§ 371 Date: Aug. 18, 2008

(30) Foreign Application Priority Data
Dec. 16, 2005 (DE) 20 2005 019 656.8

(51) Int. Cl. E05B 11/00; E05B 35/12

(52) U.S. Cl. 70/338; 70/389

(57) ABSTRACT

A latch lock having a latch which is arranged so as to be displaceable against spring force in a lock case that can be fastened to a wall, door leaf, or the like, having a first locking cylinder whose thumb draws the latch back against spring force when the cylinder core is rotated by a key. The locking cylinder is constructed in such a way that it allows the key to be pulled out only in a determined position of the cylinder core with reference to the cylinder housing such as in the locking position. According to the invention, a second locking cylinder is arranged in the lock case and coupled with the first locking cylinder such that, when rotated by means of a key, its thumb moves the first locking cylinder into the determined position in which the key can be extracted from the first locking cylinder.

The present application claims priority from PCT Patent Application No. PCT/EP2006/01684 filed on Aug. 11, 2006, which claims priority from German Patent Application No. 20 2005 019 656.8 filed on Dec. 16, 2005, the disclosure of which is incorporated herein by reference in its entirety.

### BACKGROUND OF THE INVENTION

1. Field of the Invention

The invention is directed to a latch lock having a latch which is arranged so as to be displaceable against spring force in a lock case that can be fastened to a wall, a door leaf, or the like, having a (first) locking cylinder (user cylinder) whose thumb draws the latch back against spring force when the cylinder core is rotated by means of a key, the cylinder being constructed in such a way that it allows the key to be pulled out only in a determined position of the cylinder core in the locking position.

2. Description of Related Art

A latch lock of the type mentioned above is already known, for example, from Catalog Sheet 1-300 of the catalog “Modular Hardware Systems, DIRAK-Guide 2004/2005” by the firm DIRAK GmbH & Co. KG, Königsfelder Str. 1, 58256 Ennepetal, Germany.

The known latch lock can be locked again in any position of the key by snapping it closed. By bringing the key back again into its starting position after closing, the key can also easily be withdrawn and used again for the same door or for other doors.

### SUMMARY OF THE INVENTION

There are applications in which it is desirable to prohibit such reuse of the key by preventing the key from being removed again after the closure has been closed without undertaking any special steps. Therefore, the key will only be removed again and reused if the blocking of the first key is canceled by another key.

This object is met in that a second locking cylinder (master cylinder/blocking cylinder) is arranged in the lock case in such a way and coupled with the first cylinder in such a way that, when rotated by means of a key, its thumb moves the first cylinder into the determined position in which the key can be extracted from the first cylinder.

For example, the following can be achieved in this way: A customer pays for an item at the register and receives a key with which to open a lock box containing the corresponding quantity of the purchased item. The key remains in the lock and cannot be reused by the customer, for example, to open another box for which the same key is provided.

The key remains locked in the closure until, for example, a store employee unlocks it with a master key and can remove the user key and the process can be repeated with renewed use of the deposit box.

The latch lock can be realized in a simple manner in that the two locking cylinders are arranged next to one another and have, as thumbs, cam disks comprising cams and cam followers, respectively, and the cams and cam followers of one locking cylinder can engage those of the other locking cylinder.

In particular, it is conceivable that one cam disk (actuating cam disk) of the first locking cylinder is connected with the actuating shaft of the first locking cylinder so as to be rigid with respect to rotation relative to it, while the cam disk (blocking cam disk) of the second locking cylinder is connected to the actuating shaft of the second locking cylinder with a fixed rotational play, and an over-center spring forces the cam disk into one or the other end position of rotational play.

The above-mentioned over-center spring can be a coil spring, one of whose ends is connected to a first arm proceeding from the cam disk (blocking cam disk) of the second locking cylinder, while its other end is connected to the lock case.

It is advantageous when the over-center spring forces the first arm of the blocking cam disk in a first direction against a stop face formed by the wall of the lock case or—in the opposite, second direction—against a first cam carried by the actuating cam disk.

It is particularly advantageous when the actuating cam disk has a first cam and a second cam which are substantially located radially opposite one another with reference to the axis of rotation of the actuating cam disk and when the blocking cam disk has a first arm and a second arm arranged in such a way that in the one end position of the blocking cam disk the arms engage the cams in such a way that the actuating cam disk is prevented from rotating.

This prevents a new actuation of the key for turning into the extracting position.

The actuating cam disk can have an arm which draws the latch back into the lock case when the user cylinder is rotated in the opening direction. This is the normal possibility for opening before the blocking process.

The actuating cam disk can have another arm which is substantially located radially opposite to the first arm with reference to the axis of rotation of the disk, this arm engaging a cam or recessed surface of the blocking cam disk in such a way that when the user cylinder rotates in the opening direction the arms of the blocking cam disk are moved into the position in which the actuating cam disk is prevented by spring force from rotating back.

This prevents the starting condition from being reached again in an unwanted manner.

The spring force can be supplied by a coil spring which lies coaxial to the axis of rotation of the actuating cam disk and which is supported by one of its ends in the lock housing and by its other end at the actuating cam disk.

It is advantageous when the latch comprises a spring-loaded bolt with a stop bevel in the customary way, which bolt penetrates a side wall of the lock case and should have a cam which can be engaged by an arm of the actuating cam disk.

The lock case can have a top from which bearing surfaces for the locking cylinders project into the interior of the case and which is penetrated in outward direction by the locking cylinders.

Further, the lock case can have a flange formed by the top and two yielding projections which proceed from oppositely located side walls and which recede in a snap-like manner when the lock case is inserted into a corresponding opening in a thin wall to move past the edge of the opening and then spring back and clamp the thin wall between themselves and the stop surface of the flange.

### BRIEF DESCRIPTION OF THE DRAWINGS

FIG. 1A is a side view illustrating the use of the latch lock constructed according to the invention;

FIG. 1B is a top view of the latch lock according to FIG. 1A;

FIG. 1C shows a left-hand view of the latch lock according to the invention installed in a door leaf;

FIG. 2 shows an exploded view of the arrangement according to FIGS. 1A to 1C;

FIG. 3 is a rear view showing the interior of the latch lock according to the invention in a position corresponding to the starting position;

FIG. 4 shows the state after rotation of the user key by, initially, 15° compared to FIG. 3;

FIG. 5A shows the drawing-back process;

FIG. 5B shows the drawing-back process, in section;

FIG. 6 shows the latch in the fully drawn back state; in this position, the actuating cylinder is rotated by a total of 25°;

FIG. 7A shows the state after opening the door;

FIG. 7B shows a section through the arrangement according to FIG. 7A for showing a normally covered arm of the user disk;

FIG. 8 shows the state after the blocking cylinder has been actuated by the supervising person; this configuration corresponds to that of FIG. 4; in this position from FIG. 8, the start positions according to FIG. 3 are achieved again.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

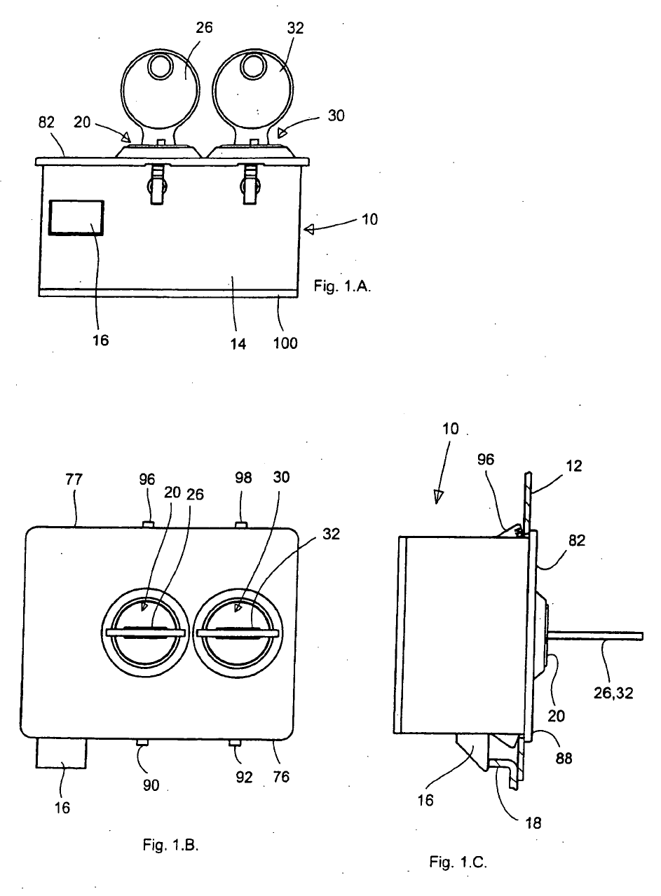

FIG. 1A shows a latch lock 10 with a latch 16 which is arranged so as to be displaceable against spring force in a lock case 14 that can be fastened to a wall or a door leaf 12 or the like (see FIG. 1C), which latch 16 makes contact behind a surface that is formed by the frame, for example, according to FIG. 1C. The latch lock 10 has a first locking cylinder (user cylinder) 20 whose thumb 22 draws the latch 16 back against spring force when the cylinder core 24 is rotated by means of a key 26. The cylinder 20 is constructed in such a way that it allows the key 26 to be pulled out only in a determined position of the cylinder core 24 with reference to the cylinder housing 28, such as a lock position. As can also be seen from FIG. 1A, a second locking cylinder (master cylinder) 30 is arranged in the lock case 14 in such a way and is coupled with the first cylinder 20 in such a way that, when rotated by means of a key 32, its thumb 34 moves the first cylinder 20, or makes the latter movable, into the determined position in which the key 26 can be extracted from the first cylinder 20.

To this end, the two locking cylinders are arranged next to one another (see FIG. 1A), and the thumbs 22, 34 are constructed as cam disks comprising cams 36, 40, 46 and cam followers 42, 44, 38, respectively, and the cams and cam followers 22, 36, 38, 40 of one locking cylinder 20 can engage those 30, 42, 44, 46 of the other locking cylinder.

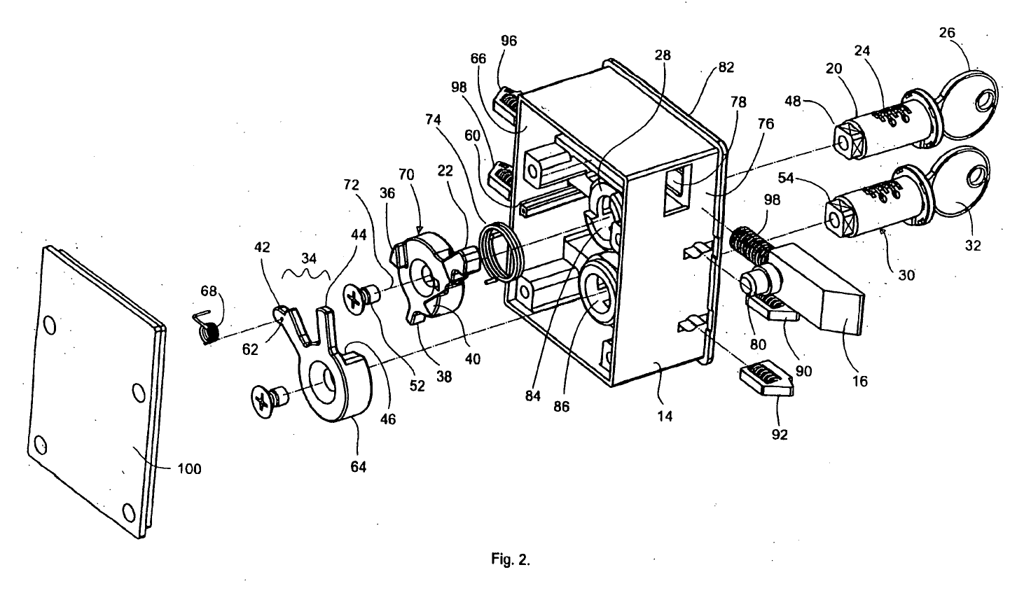

As can be seen from FIG. 2, the cam disk (actuating cam disk) 22 of the first locking cylinder 20 is connected with its actuating shaft 24 so as to be rigid with respect to rotation relative to it, specifically by means of the square 48 which can be introduced into a corresponding recess 50 in the actuating cam disk 22 (see FIG. 5B) and which is connected by a head screw 52 at that place and accordingly with the actuating shaft so as to be rigid against rotation, while the cam disk (blocking cam disk) 34 of the second locking cylinder 30 is connected to the actuating shaft of the latter with a fixed rotational play (see the square 54 of the locking cylinder 30 which has a recess 56 allowing a play of approximately 30°).

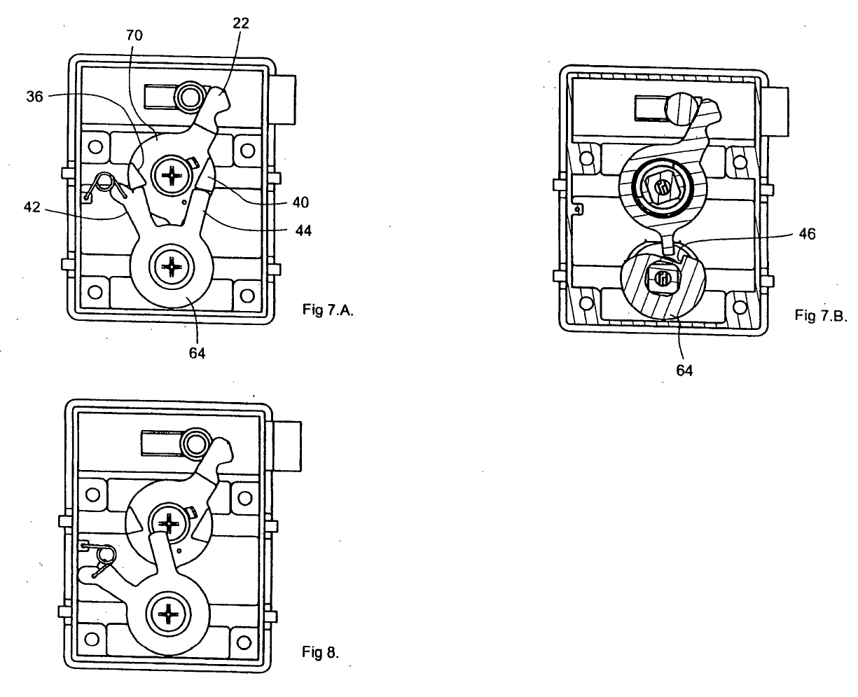

An over-center spring 58, a coil spring, one of whose ends is connected to a first arm 42 proceeding from the cam disk (blocking cam disk) of the second locking cylinder 30, while its other end is connected to the lock case in FIG. 6C, ensures that the cam disk 64 is forced into one end position of the rotational play and, after overcoming the dead center of the spring arrangement, into the other end position of the rotational play (see FIGS. 7A and 8).

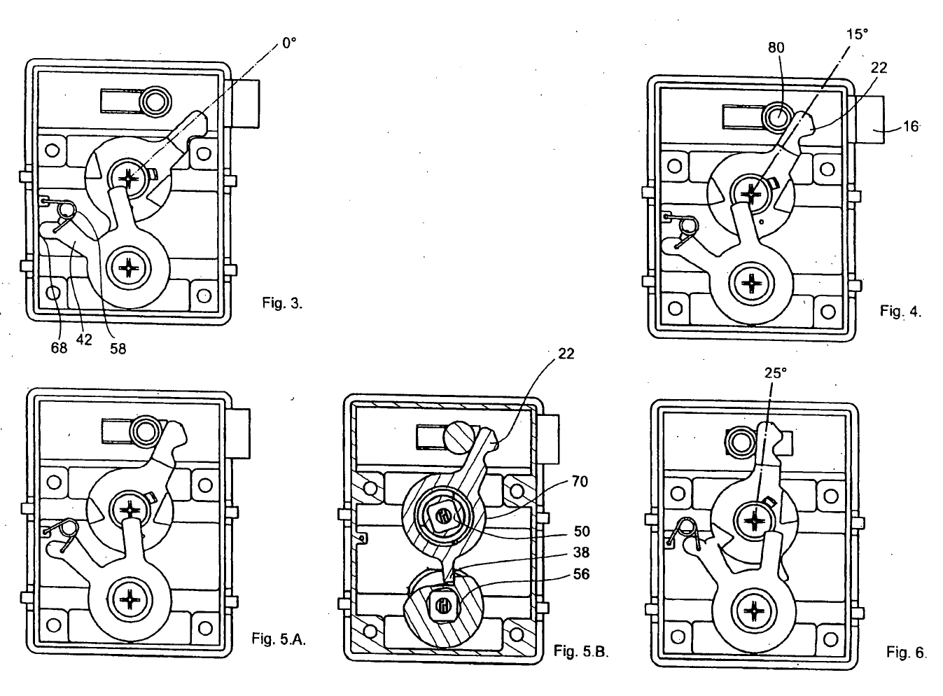

As can be seen from FIG. 8, the over-center spring 58 forces the first arm 42 of the blocking cam disk 64 against a stop face 68 formed by the lock case wall 66 in a first direction (see FIG. 3) or—in the opposite, second direction—against a first cam 36 carried by the actuating cam disk 70. The actuating cam disk 70 has a first cam 36 and a second cam 40 which are located substantially radially opposite one another with respect to the axis of rotation 72 of the actuating cam disk 70, while the blocking cam disk 64 has a first arm 42 and a second arm 44 arranged in such a way that in one end position of the blocking cam disk (see FIG. 7A) the cams 36, 40 engage with one another in such a way that the actuating cam disk 70 is prevented from rotating.

Apart from that, the actuating cam disk 70 has another arm 22 which draws the latch 16 back into the lock case 14 when the user cylinder 24 is rotated in the opening direction.

The actuating cam disk 70 has another arm 38 which lies substantially radially opposite to the first arm 22 with reference to the axis of rotation of the disk 72, which arm 38 engages a cam or a recessed surface 46 of the blocking cam disk 64 in such a way that when the user cylinder 20 rotates in the opening direction, the counterclockwise direction according to FIG. 5B, the arms 42, 44 of the blocking cam disk 64 are moved into the position in which the actuating cam disk 70 is prevented by the force of a spring 74 from rotating back.

Also, the latch 16 is loaded by the spring 98. Apart from this, the latch comprises a spring-loaded bolt with a stop bevel. This bolt 16 penetrates a side wall 76 of the lock case 14 via opening 78. Further, the bolt 16 has a cam 80 which can be engaged by an arm 22 of the actuating cam disk 70 (see, for example, the sequence illustrated in FIGS. 3 to 6).

According to FIGS. 1A and 1C, the lock case 14 has a top 82 from which bearing surfaces 84, 86 for the core 24 of the locking cylinder 20 and 30, respectively, project into the interior of the case (see FIG. 2) and which top 82 is penetrated in outward direction by the locking cylinders.

Further, the lock case 14 has a flange 88 formed by the top 82 and also two yielding projections 90, 92, 94, 96 projecting from oppositely located side walls 66, 76 of the case 14. These projections can recede in a snap-like manner when the lock case 14 is inserted into a corresponding opening in a thin wall so as to allow the edge of the opening to move past and then spring back and clamp the thin wall between themselves and the stop surface of the flange (see FIG. 1C).

The case 14 can be closed on the rear side by a cover 100.

The lock works in the following way: Starting with FIG. 3, which shows the operation-ready position, in this position the user's key 26 can be inserted into the cylinder 20 and rotated in clockwise direction in the locking cylinder core 24. After a rotational path of 15°, for example, the arm 22 strikes the pin 80 of the bolt 16 at the latch bolt 16. While continuing to rotate to 25°, the position shown in FIG. 6, in which the bolt 16 is completely pulled in against the pressure of the spring, is reached by way of the position shown in FIG. 5A. The master cylinder 30 is connected to the cam disk 64 by a freewheel which allows it to rotate freely over an angle of 30° (to name one example). The cam disk 64 has two end positions, both of which are secured by the same over-center spring 58. In the ready-to-use state shown in FIG. 3, the arm 42 to which the over-center spring 58 is connected rests against the side of the lock case so that the latter acts as a stop 68. During the last 10 degrees of the rotating movement and, therefore, of the thrusting movement of the bolt 16 in direction of its drawn back position, the locking cam disk 64 “flips over”, but not completely, until the end of the movement is finally reached (in which the bolt is drawn back). When the user's key is rotated back by 10° from the 25-degree position after opening the door so that the position at 15° according to FIG. 4 is achieved (see FIG. 7A), the blocking cam disk 64 prevents the actuating cam disk 70 and, therefore, the actuating locking cylinder 20 from being rotated back farther in direction of the starting point. The arm 44 on the right-hand side referring to FIG. 7A prevents this. When the user cylinder has reached the 15-degree position, as can be seen in FIG. 4, the blocking cam disk is rotated almost fully to its end position and prevents the actuating cam disk from being rotated a second time in the opening direction. In this way, the user cylinder is blocked in the 15-degree position and it cannot be rotated in either direction. Since the cylinder cannot then be rotated far enough into the starting position, the user's key cannot be removed. This status is shown in FIGS. 7A and 7B.

In order to move the lock back again into the state where it can be used, the master cylinder 30 must be rotated by 30° in clockwise direction. In doing so, the cam disk 64 is flipped back as shown in FIG. 8 and the starting position according to FIG. 3 is reached. The master key can now be pulled out again. Driven by an integrated spring 74, the user cylinder and the actuating disk fall back into their starting position so that the user's key can be pulled out.

The door can be closed in every position of the locking cylinder and cam disk.

### COMMERCIAL APPLICABILITY

The invention is commercially applicable in switch cabinet construction.

### REFERENCE NUMBERS

10 latch lock
12 wall, door leaf
14 lock case
16 latch
18 frame
20 first locking cylinder (user cylinder)
22 thumb
24 cylinder core
26 key
28 cylinder housing
30 second locking cylinder (master cylinder)
32 key
34 thumb
36 cam
38 arm, cam follower
40 cam
42 arm, cam follower
44 arm, cam follower
46 stop face, cam
48 square
50 recess
52 head screw
54 square
56 recess with play
58 over-center spring
60 housing connection point
62 cam connection point
64 blocking cam disk
66 lock case wall
68 stop face
70 actuating cam disk
72 axis of rotation
74 spring
76 side wall
77 side wall
78 opening
80 cam
82 top
84 bearing surfaces
86 bearing surfaces
88 flange
90 projection
92 projection
94 projection
96 projection
98 spring
100 cover

1-12. (canceled)

13. A latch lock comprising:
a latch which is arranged so as to be displaceable against spring force in a lock case that can be fastened to a wall, a door leaf, or the like;
wherein the latch has a first locking cylinder whose thumb draws the latch back against spring force when the cylinder core is rotated by means of a key, the first locking cylinder being constructed in such a way that it allows the key to be pulled out only in a determined position of the cylinder core with reference to the cylinder housing such as in the locking position;
wherein a second locking cylinder is arranged in the lock case in such a way and coupled with the first locking cylinder in such a way that when rotated by means of a key its thumb moves the first locking cylinder into the determined position in which the key can be extracted from the first locking cylinder;
wherein the first and second locking cylinders are arranged next to one another and have, as thumbs, cam disks comprising cams and cam followers, respectively;
wherein the cams and cam followers of the cam disk of one of the two locking cylinder can engage those of the cam disk of the other locking cylinder; and
wherein the cam disk of the first locking cylinder is connected with the actuating shaft of the first locking cylinder so as to be rigid with respect to rotation relative to it, while the cam disk of the second locking cylinder is connected to the actuating shaft of the second locking cylinder with a fixed rotational play, and an over-center spring forces the blocking cam disk into one or the other end position of rotational play.

14. The latch lock according to claim 13;
wherein the over-center spring is a coil spring, one of whose ends is connected to a first arm proceeding from the cam disk of the second locking cylinder, while its other end is connected to the lock case.

15. The latch lock according to claim 14;
wherein the over-center spring forces the first arm of the blocking cam disk in a first direction against a stop face formed by the wall of the lock case or in the opposite, second direction against a first cam carried by the actuating cam disk.

16. The latch lock according to claim 15;
wherein the actuating cam disk has a first cam and a second cam which are substantially located radially opposite one another with reference to the axis of rotation of the actuating cam disk; and
wherein the blocking cam disk has a first arm and a second arm arranged in such a way that in the one end position of the blocking cam disk the arms engage the cams of the actuating cam disk in such a way that the actuating cam disk is prevented from rotating.

17. The latch lock according to claim 13;
wherein the actuating cam disk has an arm which draws the latch back into the lock case when the user cylinder is rotated in the opening direction.

18. The latch lock according to claim 17;
wherein the actuating cam disk has another arm which is substantially located radially opposite to the first arm with reference to the axis of rotation of the cam disk, this arm engaging a cam or recessed surface of the blocking cam disk in such a way that when the user cylinder rotates in the opening direction the arms of the blocking cam disk are moved into the position in which the actuating cam disk is prevented by spring force from rotating back.

19. The latch lock according to claim 18;
wherein the spring force is supplied by a coil spring which lies coaxial to the axis of rotation of the actuating cam disk and which is supported by one of its ends in the lock housing and by its other end at the actuating cam disk.

20. The latch lock according to claim 13;
wherein the latch comprises a spring-loaded bolt with a stop bevel, which bolt penetrates a side wall of the lock case and has a cam which can be engaged by an arm of the actuating cam disk.

21. The latch lock according to claim 13;
wherein the lock case has a top from which bearing surfaces for the locking cylinders project into the interior of the case, and which top is penetrated in outward direction by the locking cylinders.

22. The latch lock according to claim 21;
wherein the lock case has a flange formed by the top; and
wherein two yielding projections proceed from oppositely located side walls and recede in a snap-like manner when the lock case is inserted into a corresponding opening in a thin wall in order to allow the edge of the opening to move past and then spring back and clamp the thin wall between themselves and the stop surface of the flange on the thin wall.
